(19) United States
(12) Patent Application Publication
(10) Pub. No.: US 2013/0080061 A1
(43) Pub. Date: Mar. 28, 2013

(54) SYSTEM AND METHOD FOR DETERMINING INFORMATION RELATED TO SUB-SURFACE GEOLOGICAL FORMATIONS USING TIME-DEPENDENT MAGNETIC FIELDS

(71) Applicants: Mark A. Ruths, Sugar Land, TX (US); George Nickel, Santa Fe, NM (US); Cole Thomas Brinkley, Peralta, NM (US); Daniel L. Neagley, Albuquerque, NM (US)

(72) Inventors: Mark A. Ruths, Sugar Land, TX (US); George Nickel, Santa Fe, NM (US); Cole Thomas Brinkley, Peralta, NM (US); Daniel L. Neagley, Albuquerque, NM (US)

(73) Assignee: CHEVRON U.S.A. INC., San Ramon, CA (US)

(21) Appl. No.: 13/625,743

(22) Filed: Sep. 24, 2012

Related U.S. Application Data
(60) Provisional application No. 61/538,589, filed on Sep. 23, 2011.

(51) Int. Cl. G01V 3/26; G01V 3/38

(52) U.S. Cl. 702/9

(57) ABSTRACT

A time-dependent magnetic field and/or flux is implemented to determine information related to geological formations within the geologic volume of interest. Such information may include one or more of location, boundary or shape, pressure, faults, lithology, strength, and/or other information. A source of the time-dependent magnetic field and/or flux may leverage the operation of an excavation tool used to excavate a hole at or near the geologic volume of interest in order to generate the magnetic field and/or flux. A plurality of different sources may be used to generated the magnetic field and/or flux.

### PRIORITY

This application claims priority under 35 U.S.C. §119(e) from U.S. Provisional Patent Application No. 61/538,589, entitled METHOD AND APPARATUS FOR DETECTING SUBSURFACE GEOLOGIC FEATURES, and filed Sep. 23, 2011, which is incorporated by reference into the present disclosure in its entirety.

### FIELD

The disclosure relates to implanting time-dependent magnetic field or flux within a geologic volume of interest to determine information related to one or more geological formations therein.

### BACKGROUND

It is known that being able to obtain information related to a geologic volume of interest at or near a hole being excavated (e.g., for the extraction of petrochemicals) would be advantageous. However, present techniques provide limited information with respect to such geologic volumes of interest.

### SUMMARY

One aspect of the disclosure relates to a system configured to determine information related to geological formations within a geologic volume of interest. The system may include one or more sensors, one or more processors, and/or other components. The one or more sensors are configured to generate output signals conveying information related to magnetic field and/or flux within the geological volume of interest. The one or more processors execute a field generation module, a field detection module, a field modeling module, and/or other modules. The field generation module is configured to determine one or more parameters of an induced magnetic field and/or flux induced by one or more sources disposed within a hole in the Earth at or near the geologic volume of interest during excavation of the hole by an excavation tool, wherein the one or more sources include a first source that causes one or more parameters of the induced magnetic field and/or flux to vary as function of the operation of the excavation tool during excavation of the hole. The field detection module is configured to determine one or more parameters of a response magnetic field and/or flux through the geologic volume of interest that is caused by the induced magnetic field and/or flux. The feature modeling module is configured to determine information related to a geological formation within the geologic volume of interest based on the one or more parameters of the response magnetic field and/or flux determined by the field detection module.

Another aspect of the disclosure relates to a computer-implemented method of determining information related to geological formations within a geologic volume of interest. The method is implemented in a computer system that includes one or more physical processors. The method comprises generating, with one or more sensors, output signals conveying information related to magnetic field and/or flux within the geological volume of interest; determining, with one or more processors, one or more parameters of an induced magnetic field and/or flux induced by one or more sources disposed within a hole in the Earth at or near the geologic volume of interest during excavation of the hole by an excavation tool, wherein the one or more sources include a first source that causes one or more parameters of the induced magnetic field and/or flux to vary as function of the operation of the excavation tool during excavation of the hole; determining, with one or more processors, one or more parameters of a response magnetic field and/or flux through the geologic volume of interest that is caused by the induced magnetic field and/or flux; and determining, with one or more processors, information related to a geological formation within the geologic volume of interest based on the determined one or more parameters of the response magnetic field and/or flux.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to determine information related to geological formations within a geologic volume of interest.

FIG. 2 illustrates a method for determining information related to geological formations within a geologic volume of interest.

### DETAILED DESCRIPTION

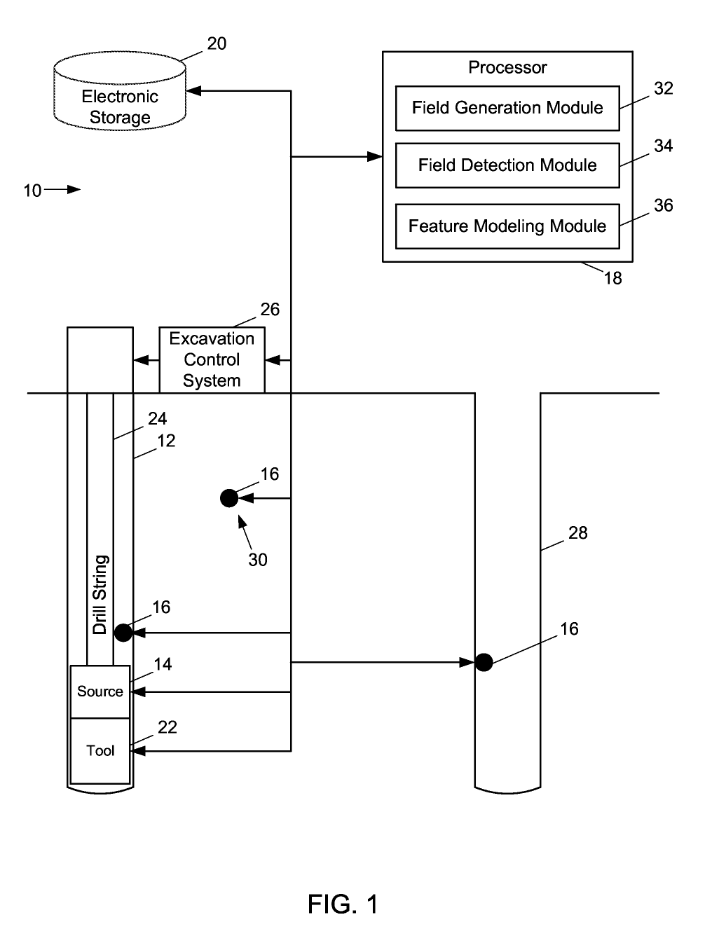

FIG. 1 illustrates a system 10 configured to determine information related to geological formations within a geologic volume of interest. System 10 implements one or more time-dependent magnetic field and/or flux to determine information related to geological formations within the geologic volume of interest. Such information may include one or more of location, boundary or shape, pressure, faults, lithology, strength, conductivity, and/or other information. The information determined by system 10 may be implemented in the formation of a hole 12 being formed in the geologic volume of interest, for example, for the extraction of petrochemicals. In some implementations, system 10 may include one or more of one or more sources 14, one or more sensors 16, one or more processors 18, electronic storage 20, and/or other components.

Hole 12 is formed as a hole in the Earth at or near the geologic volume of interest. Hole 12 may be maintained, at least through part of its depth, by one or more casings or completions (not shown). Hole 12 may be configured to facilitate the extraction of petrochemicals. Hole 12 may be formed for the purpose of obtaining information about the geologic volume of interest to facilitate the formation of another hole through the geologic volume of interest (e.g., to be used for petrochemical extraction and/or for other purposes).

Hole 12 is excavated by an excavation tool 22 disposed on a distal end of a drill string 24 in hole 12. Excavation tool 22 is configured to break, pulverize, remove, and/or excavate geologic material in other ways to increase the depth and/or diameter of hole 12. By way of non-limiting example, excavation tool 22 may include one or more of a drill bit, a reamer, a pulsed power drilling apparatus, and/or other excavation tools. Excavation tool 22 may be rotated by drill string 24 in order to effect excavation of hole 12. Excavation tool 22 may be configured to excavate hole 12 without being rotated. A pulsed power drilling apparatus is an apparatus configured to excavate geologic material through the use of pulsed power. By inducing an electrical potential across electrodes in contact with geologic material, an arc or plasma is formed inside the geologic material. The hot gases created by the arc or plasma fractures the geologic material. The high temperature of the arc or plasma may vaporize the geologic material. For example, the pulsed power drilling apparatus may be provided as described in one or more of U.S. Pat. Nos. 7,416,032 (issued Aug. 26, 2008); 7,530,406 (issued May 12, 2009); and/or 8,172,006 (issued May 8, 2012); and/or U.S. Patent Application Publication No. 2012/0168177 (filed Jan. 9, 2012), which are each incorporated by reference into the present disclosure in their entirety.

Excavation of hole 12 by excavation tool 22 is controlled by an excavation control system 26. Excavation control system 26 may monitor and/or control various operating parameters of excavation tool 22. These operating parameters may include a rotational parameter (e.g., rotational velocity, frequency, angular acceleration, rotational orientation, and/or other rotational parameters), a power parameter of a pulsed power drilling apparatus (e.g., potential, current, power, and/or other power parameters), timing parameter of a pulsed power drilling apparatus (e.g., pulse frequency, duty cycle, pulse length, pulse beginning, pulse ending, and/or other timing parameters), a drill force parameter (e.g., torque, force on bit, weight on bit, and/or other drill force parameters), and/or other operational parameters of excavation tool 22.

Source 14 is configured to induce an induced magnetic field and/or flux. The induced magnetic field and/or flux is time-dependent. Source 14 is configured such that the time-dependence of one or more parameters of the induced magnetic field and/or flux varies as a function of the operation of excavation tool 22. For example, source 14 may include one or more permanent magnets mounted to excavation tool 22 and/or a portion of drill string 24 that rotates with excavation tool 22. As used herein, a permanent magnet may include a material that has been magnetized to the extent that the crystalline structure of the material facilitates preservation of the magnetic charge carried by the material so that the magnetic charge does not substantially dissipate over time and/or in the presence of a magnetic field and/or flux created externally from the material. By virtue of the rotation of the permanent magnet(s), the magnetic field and/or flux induced by source 14 rotates over time. The rotation may be proportional (e.g., 1:1, or other proportions) to the rotation of excavation tool 22. In some implementations, source 14 induces the induced magnetic field and/or flux while excavation tool 22 is not rotating. This may be implemented with a pulsed power drilling apparatus that does not rotate, while a drill bit is at rest rotationally, and/or in other circumstances in which excavation tool 22 is not rotating.

In some implementations, source 14 and excavation tool 22 may overlap (e.g., they may have one or more components in common). For example, a pulsed power drilling apparatus may, by virtue of the pulsed power it dispenses, may generate, at least in part, the induced magnetic field and/or flux. The induced magnetic field and/or flux may thus vary as a function of one more of the operating parameters of the pulsed power drilling apparatus. The one or more operating parameters that cause the induced magnetic field and/or flux to vary over time may include one or more of a power parameter, a timing parameter, and/or other parameters.

Diffusion of the induced magnetic field within the geologic volume of interest, in turn, induces currents within electrically conductive geologic structures and/or anomalies, such as fractures, gas chambers, brine layers, oil, and/or other structures. The magnetic dipole induced in these structures by the induced current produces a response field and/or flux in the geologic volume of interest.

Sensors 16 are configured to generate output signals conveying information related to magnetic field and/or flux within the geologic volume of interest. The output signals may indicate information related to the induced magnetic field and/or flux, the response magnetic field and/or flux, and/or other sources of magnetic field and/or flux in the geologic volume of interest. By way of non-limiting example, sensors 16 may include a magnetometer and/or other sensors. As is shown in FIG. 1, sensors 16 may include one or more sensors disposed within hole 12 (e.g., on drill string 24, in a casing or completion, and/or at other locations in hole 12), in a second hole 28 that is at or near the geologic volume of interest, at another subsurface location 30 that is at or near the geologic volume of interest, and/or at other locations. The illustration and description of sensors 16 as including separate sets of one or more sensors at the different locations of FIG. 1 is not intended to be limiting. Sensors 16 could be disposed at more and/or fewer locations than are shown in FIG. 1.

Processor 18 is configured to execute one or more computer program modules in order to determine information related to one or more geological formations within the geologic volume of interest. The computer program modules may include one or more of a field generation module 32, a field detection module 34, a feature modeling module 36, and/or other modules.

Field generation module 32 is configured to determine one or more parameters of the induced magnetic field and/or flux that is induced by source 14. This includes determining the one or more parameters as a function of time as the induced magnetic field and/or flux fluctuates. The one or more parameters may include one or more of flux, strength, orientation, polarity, and/or other parameters. The one or more parameters of the induced magnetic field and/or flux may be determined based on one or more of the output signals from sensors 16, one or more operating parameters of excavation tool 22, and/or other factors. By way of example, field generation module 32 may obtain one or more operating parameters of excavation tool 22 from excavation control system 26, and may implement the obtained operating parameters in determining the induced magnetic field and/or flux. In some implementations, some or all of the functions attributed herein to excavation control system 26 may be performed by processor 18 (e.g., through the execution of one or more additional modules). Excavation control system 26 may obtain the operating parameters of excavation tool 22 through monitoring the operation of excavation tool 22 from control inputs to excavation tool 22 (e.g., specified levels for the operating parameters), and/or through other techniques.

In implementations in which source 14 includes a plurality of sources, source 14 may include other types of sources in addition to and/or in place of a permanent magnet and/or a pulsed power drilling apparatus. The other types of sources may include, for example, an electromagnet, and/or other magnetic sources. Field generation module 32 may be configured to determine the combined induced magnetic field and/or flux produced by the sources as a whole. This would include determining the induced magnetic field and/or flux as a function of magnetic field and/or flux generated by all of the sources included in source 14.

Field detection module 34 is configured to determine one or more parameters of the response magnetic field and/or flux. Field detection module 24 determines the one or more parameters of the response magnetic field and/or flux based on the output signals generated by sensors 16. The one or more parameters of the response magnetic field and/or flux determined by field detection module 34 may include one or more of flux, strength, orientation, polarity, and/or other parameters.

Feature modeling module 36 is configured to determine information related to one or more geological formations in the geologic volume of interest based on one or more of the induced magnetic field and/or flux (e.g., as determined by field generation module 32), the response magnetic field and/or flux (e.g., as determined by field detection module 34), and/or other factors. The information related to the one or more geological formations may include one or more of location, boundary or shape, pressure, faults, lithology, strength, electrical conductivity, and/or other information. In some implementations, feature modeling module 36 may be configured to combine the information determined from the induced magnetic field and/or flux and/or the response magnetic field and/or flux with one or more other measurements that provide information about geological formations in the geologic volume of interest. Such other measurements may include, for example, acoustic, gravitational, or seismic imaging, and/or other measurements.

Processor 18 may be configured to provide results of one or more of the operations performed by modules 32, 34, and/or 36 to one or more users. The results may be provided to the one or more users via a user interface (not shown). The user interface may include a graphic display of text and/or graphics depicting the results, non-transient electronic storage media to which the results are stored, a network location or site through which the results are conveyed, and/or other user interfaces.

Excavation control system 26 and/or processor 18 may be configured to adjust control of excavation tool 22 based on the results of the operations performed by modules 32, 34, and/or 36. For example, one or more of the operating parameters of excavation tool 22 may be adjusted, the orientation, planned depth, diameter, and/or other parameters of hole 12 may be adjusted, and/or other aspects of the operation of excavation tool 22 may be adjusted based on the results.

Processor 18 is configured to provide information processing capabilities in system 10. As such, processor 18 may include one or more of a digital processor, an analog processor, a digital circuit designed to process information, an analog circuit designed to process information, a state machine, and/or other mechanisms for electronically processing information. Although processor 18 is shown in FIG. 1 as a single entity, this is for illustrative purposes only. In some implementations, processor 18 may include a plurality of processing units. These processing units may be physically located within the same device, or processor 18 may represent processing functionality of a plurality of devices operating in coordination.

Processor 16 may be configured to execute modules 32, 34, and/or 36 by software; hardware; firmware; some combination of software, hardware, and/or firmware; and/or other mechanisms for configuring processing capabilities on processor 16.

It should be appreciated that although modules 32, 34, and 36 are illustrated in FIG. 1 as being co-located within a single processing unit, in implementations in which processor 16 includes multiple processing units, one or more of modules 32, 34, and/or 36 may be located remotely from the other modules. The description of the functionality provided by the different modules 32, 34, and/or 36 described below is for illustrative purposes, and is not intended to be limiting, as any of modules 32, 34, and/or 36 may provide more or less functionality than is described. For example, one or more of modules 32, 34, and/or 36 may be eliminated, and some or all of its functionality may be provided by other ones of modules 32, 34, and/or 36. As another example, processor 16 may be configured to execute one or more additional modules that may perform some or all of the functionality attributed below to one of modules 32, 34, and/or 36.

Electronic storage 20 comprises electronic storage media that non-transiently stores information. The electronic storage media of electronic storage 20 may include one or both of system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 20 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 20 may include virtual storage resources, such as storage resources provided via a cloud and/or a virtual private network. Electronic storage 20 may store software algorithms (e.g., associated with modules 32, 34, and/or 36), information determined by processor 18, and/or other information that enables system 10 to function properly. Electronic storage 20 may be a separate component within system 10, or electronic storage 20 may be provided integrally with one or more other components of system 10 (e.g., processor 18).

The illustration and description herein of source 14 and/or sensor 16 being provided down hole 12 via drill string 24 is not intended to be limiting. Other mechanisms may be implemented to position and/or install source 14 and/or sensor 16 in place within hole 12. For example, a wireline may be implemented in the place of drill string 24.

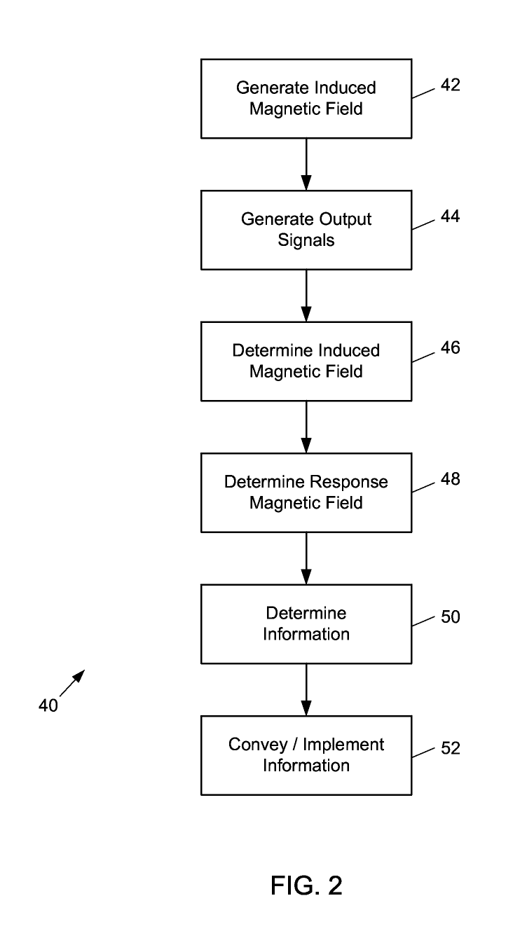

FIG. 2 illustrates a method 40 of determining information related to a geological formation within a geologic volume of interest. The operations of method 40 presented below are intended to be illustrative. In some embodiments, method 40 may be accomplished with one or more additional operations not described, and/or without one or more of the operations discussed. Additionally, the order in which the operations of method 40 are illustrated in FIG. 2 and described below is not intended to be limiting.

In some embodiments, method 40 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 40 in response to instructions stored electronically on an electronic storage medium. The one or more processing devices may include one or more devices configured through hardware, firmware, and/or software to be specifically designed for execution of one or more of the operations of method 40.

At an operation 42, an induced magnetic field and/or flux is generated within the geologic volume of interest. The induced magnetic field and/or flux is time-dependent such that one or more parameters of the induced magnetic field and/or flux vary over time. In some implementations, operation 42 is performed by one or more sources the same as or similar to source 14 (shown in FIG. 1 and described herein). A first source included in the one or more sources may be disposed within a hole at or near the geologic volume of interest. The first source may cause one or more parameters of the induced magnetic field and/or flux to vary as a function of the operation of an excavation tool that is excavating the hole.

At an operation 44, output signals conveying information related to magnetic field and/or flux within the geologic volume of interest are generated. In some implementations, operation 44 is performed by one or more sensors the same as or similar to sensors 16 (shown in FIG. 1 and described herein).

At an operation 46, one or more parameters of the induced magnetic field and/or flux are determined. In some implementations, operation 46 is performed by a processor executing a field generation module the same as or similar to field generation module 32 (shown in FIG. 1 and described herein).

At an operation 48, one or more parameters of a response magnetic field and/or flux in the geologic volume of interest are determined. The response magnetic field and/or flux is caused by the induced magnetic field and/or flux through the geologic volume of interest. The one or more parameters of the response magnetic field and/or flux are determined based on the output signals generated at operation 44. In some implementations, operation 48 is performed by a processor executing a field detection module the same as or similar to field detection module 34 (shown in FIG. 1 and described herein).

At an operation 50, information related to a geological formation within the geologic volume of interest is determined. This information may be determined based on one or more of the output signals generated at operation 44, the one or more parameters of the induced magnetic field and/or flux determined at operation 46, the one or more parameters of the response magnetic field and/or flux determined at operation 48, and/or other factors. In some implementations, operation 50 is performed by a processor executing a feature modeling module the same as or similar to feature modeling module 36 (shown in FIG. 1 and described herein).

At an operation 52, the information determined at operation 50 is conveyed to a user and/or implanted in the operation of the excavation tool excavating the hole. In some implementations, operation 52 is performed by a processor and/or excavation control system the same as or similar to processor 18 and/or excavation control system 26, respectively (shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system configured to determine information related to geological formations within a geologic volume of interest, the system comprising:
one or more sensors configured to generate output signals conveying information related to magnetic field and/or flux within the geological volume of interest;
one or more processors configured to execute computer program modules, the computer program modules comprising:
a field generation module configured to determine one or more parameters of an induced magnetic field and/or flux induced by one or more sources disposed within a hole in the Earth at or near the geologic volume of interest during excavation of the hole by an excavation tool, wherein the one or more sources include a first source that causes one or more parameters of the induced magnetic field and/or flux to vary as function of the operation of the excavation tool during excavation of the hole;
a field detection module configured to determine one or more parameters of a response magnetic field and/or flux through the geologic volume of interest that is caused by the induced magnetic field and/or flux; and
a feature modeling module configured to determine information related to a geological formation within the geologic volume of interest based on the one or more parameters of the response magnetic field and/or flux determined by the field detection module.

2. The system of claim 1, wherein the field generation module is configured to determine the one or more parameters of the induced magnetic field and/or flux based on one or more operating parameters of the excavation tool.

3. The system of claim 2, wherein the excavation tool is a pulsed power drilling apparatus, and wherein the field generation module is configured such that the one or more operating parameters include one or both of a power parameter of a pulse and/or a timing parameter of a pulse.

4. The system of claim 2, wherein the excavation tool is a rotating drill bit, wherein the first source is a permanent magnet mounted to a drill string that includes the rotating drill bit to rotate with the rotating drill bit, and wherein the field generation module is configured such that the one or more operating parameters include a rotational parameter of the drill bit.

5. The system of claim 1, wherein the one or more sources include a plurality of sources, and wherein the field generation module is configured to determine the induced magnetic field and/or flux as a function of magnetic field and/or flux generated by the plurality of sources.

6. The system of claim 1, wherein the plurality of sources include one or both of a pulsed power drilling apparatus and/or a permanent magnet.

7. The system of claim 1, wherein the one or more sensors comprise a magnetometer.

8. The system of claim 7, wherein the magnetometer is disposed in the hole.

9. A computer-implemented method of determining information related to geological formations within a geologic volume of interest, the method comprising:
generating, with one or more sensors, output signals conveying information related to magnetic field and/or flux within the geological volume of interest;
determining, with one or more processors, one or more parameters of an induced magnetic field and/or flux induced by one or more sources disposed within a hole in the Earth at or near the geologic volume of interest during excavation of the hole by an excavation tool, wherein the one or more sources include a first source that causes one or more parameters of the induced magnetic field and/or flux to vary as function of the operation of the excavation tool during excavation of the hole;
determining, with one or more processors, one or more parameters of a response magnetic field and/or flux through the geologic volume of interest that is caused by the induced magnetic field and/or flux; and
determining, with one or more processors, information related to a geological formation within the geologic volume of interest based on the determined one or more parameters of the response magnetic field and/or flux.

10. The method of claim 9, wherein the determining the one or more parameters of the induced magnetic field and/or flux is performed based on one or more operating parameters of the excavation tool.

11. The method of claim 10, wherein the excavation tool is a pulsed power drilling apparatus, and wherein the one or more operating parameters include one or both of a power parameter of a pulse and/or a timing parameter of a pulse.

12. The method of claim 10, wherein the excavation tool is a rotating drill bit, wherein the first source is a permanent magnet mounted to a drill string that includes the rotating drill bit to rotate with the rotating drill bit, and wherein the one or more operating parameters include a rotational parameter of the drill bit.

13. The method of claim 9, wherein the one or more sources include a plurality of sources, and wherein the determining the induced magnetic field and/or flux determines the induced magnetic field and/or flux as a function of magnetic field and/or flux generated by the plurality of sources.

14. The method of claim 9, wherein the plurality of sources include one or both of a pulsed power drilling apparatus and/or a permanent magnet.

15. The method of claim 9, wherein the one or more sensors comprise a magnetometer.

16. The method of claim 15, wherein the magnetometer is disposed in the hole.
